(19) United States
(12) Patent Application Publication
(10) Pub. No.: US 2003/0197804 A1
(43) Pub. Date: Oct. 23, 2003

(54) Digital camera with automatic focusing adequate for a still picture and a movie and an automatic focusing method for the same

(76) Inventor: Takeyoshi Ito, Asaka-shi (JP)

Correspondence Address: BIRCH STEWART KOLASCH & BIRCH, PO BOX 747, FALLS CHURCH, VA, 22040-0747, US

(21) Appl. No.: 10/419,870

(22) Filed: Apr. 22, 2003

(30) Foreign Application Priority Data
Apr. 22, 2002 (JP) 2002-118875

(51) Int. Cl. H04N 5/232

(52) U.S. Cl. 348/345

(57) ABSTRACT

A digital camera including a focus control mechanism for focusing the camera on a subject of the present invention includes a first and a second selector. The first selector selects either one of a first and a second pickup mode assigned to a still picture and a movie, respectively. The second selector selects either one of a first focus range advantageous for normal-range pickup and a second focus range assigned to a subject positioned in a range shorter than the first focus range. A controller causes, in the first pickup mode, the focus control mechanism to operate in the focus range selected by the second selector or causes, in the second pickup mode, the above mechanism to operated in a range including the first focus range without regard to the focus range selected by the second selector.

### BACKGROUND OF THE INVENTION

1. Field of the Invention

The present invention relates to a digital camera capable of selectively picking up a desired subject in the form of a still picture or a movie and an automatic focusing method for the same.

2. Description of the Background Art

A digital camera operable in a macro mode for picking up a subject positioned within a short range of one meter or less is conventional. In the macro mode, a focus scanning or search range in, e.g., a range-scanning or search system is set in a short range in order to focus a digital camera on a desired subject lain in a short range more rapidly than in a normal mode. In the range-scanning system, the focus of a lens system is varied from a short distance to an object to infinity, and then focusing on the object is detected while determining which of the pictures presents the highest sharpness. However, a digital camera operable in the macro mode in both of a still picture mode and a movie mode has a problem that the macro mode must be selected even in the movie mode when a desired subject lies in a short range. Moreover, in the movie mode, because the range to the subject is not always constant, the macro mode makes it difficult to advantageously adjust the focus throughout the movie mode operation when selected.

Japanese patent laid-open publication No. 164606/1998, for example, discloses a digital camera selectively operable in a movie or a still picture mode and advantageous for short-range pickup. More specifically, this digital camera is constructed to determine, when the movie mode is selected, whether or not a desired subject lies in a short range and automatically replaces, if the subject lies in a short range, the movie mode with the still picture mode. This, however, prevents the subject lying in a short range to be desirably picked up in the movie mode.

### SUMMARY OF THE INVENTION

It is an object of the present invention to provide a digital camera allowing the operator of the camera to pickup a short-range subject in a movie mode without caring about a macro mode and maintaining the movie mode, and an automatic focusing method for the same.

In accordance with the present invention, a digital camera including a focus control mechanism for focusing the camera on a subject includes a first selecting circuit configured to select either one of a first and a second pickup mode assigned to a still picture and a movie, respectively. A second selecting circuit selects either one of a first focus range advantageous for normal-range pickup and a second focus range assigned to a subject positioned in a range shorter than the first focus range. A controller causes, in the first pickup mode, the focus control mechanism to operate in the focus range selected by the second selecting circuit or causes, in the second pickup mode, the above mechanism to operate in a range including the first focus range without regard to the focus range selected by the second selecting circuit.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing a digital camera embodying the present invention;

FIG. 2 is a flowchart useful for understanding a specific operation of a photometry and range fining controller included in the circuitry of FIG. 1;

FIG. 3 is a top planview showing a specific configuration of the digital camera; and

FIG. 4 is a rear view showing the specific configuration of the digital camera.

### DESCRIPTION OF THE PREFERRED EMBODIMENT

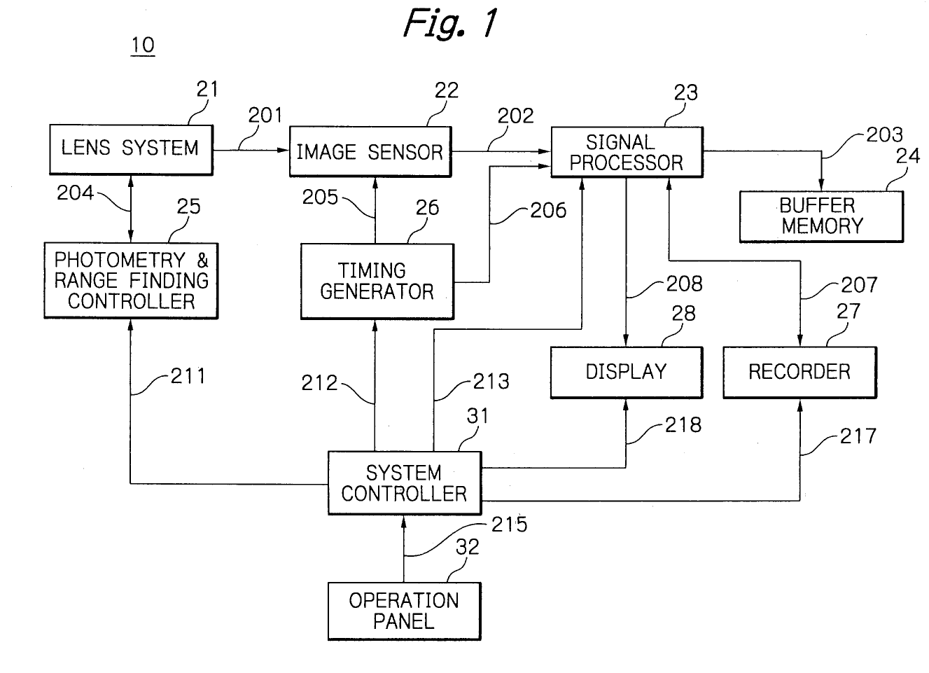

Referring to FIG. 1 of the drawings, a digital camera embodying the present invention is generally designated by the reference numeral 10. As shown, the digital camera 10 includes an optical lens system 21, a solid-state image sensor 22, a signal processor 23, a buffer memory 24, a photometry and range finding controller 25, a timing generator 26, a recorder 27, a display 28, a system controller 31, and an operation panel 32 interconnected as depicted.

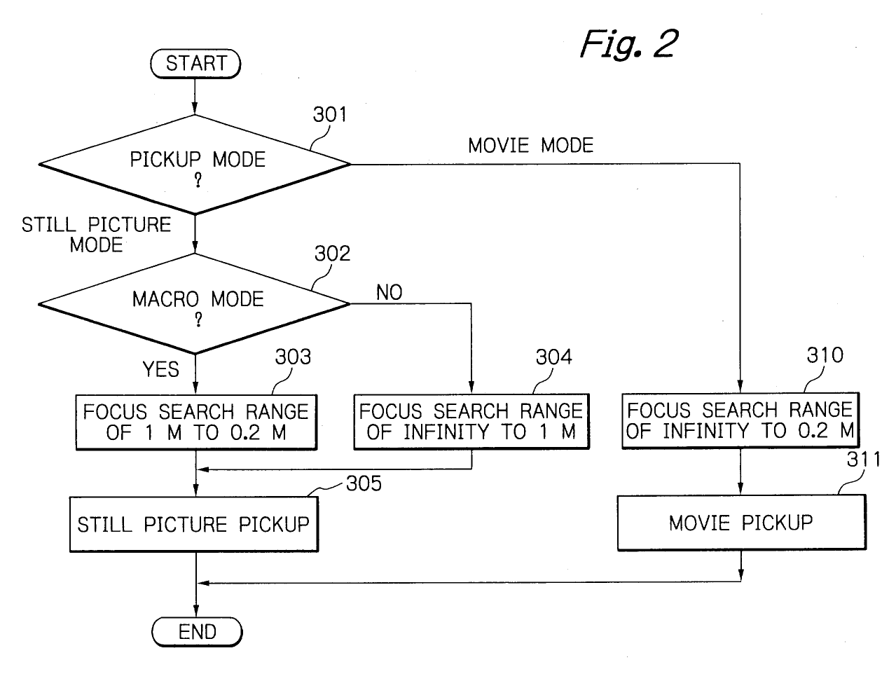

The digital camera 10 is selectively operable both in a pickup mode including a still picture and a movie modes and in a macro mode, which can be turned on or off, under the control of the system controller 31. In the illustrative embodiment, when the operator of the camera 10 selects the still picture mode as the pickup mode, a focus scanning range varies in accordance with whether or not the macro mode is turned on, as will be described in detail later with reference to FIG. 2. For example, when the macro mode is selected, a preselected range close to a subject, e.g., a range of from 1 m to 0.2 m is established as the focus scanning range. When the macro mode is not selected, the remaining range, i.e., a range between infinity and one meter in this specific case is established as the focus scanning range.

On the other hand, when the operator selects the movie mode as the pickup mode, the entire range including both of the two ranges mentioned above, e.g., from infinity to 0.2 m is established as the focus scanning range without regard to whether or not the macro mode is selected.

The lens system 21 includes a zoom and automatic focus (AF) mechanism and an automatic exposure (AE) mechanism although not shown specifically. These mechanisms are driven by control signals 204 fed from the photometry and range finding controller 25. It is to be noted that signals are designated by the reference numerals attached to signal lines on which they appear.

The system controller 31 delivers control signals, which include signals indicative of the pickup and macro modes, to the photometry and ranging finding controller 25. In response, the photometry and range finding controller 25 selects the focus scanning range assigned to the pickup and macro modes and then drives the lens system 21 with the control signals 204.

The solid-state image sensor 22 is implemented as a CCD (Charge Coupled Device) image sensor by way of example. When a light image representative of a scene being pickup is captured by the image sensor 22 through the lens system 21, the image sensor 22 photoelectrically transduces the incident light to a corresponding electric image signal 202 in response to timing pulses 205 fed from the timing generator 26. The electric image signal 202 is input to the signal processor 23. The timing generator 26 produces the timing pulses 205 from a reference operation frequency, not shown, inputted- from the system controller 31.

The signal processor 23 executes white balance adjustment, gamma correction, analog-to-digital (A/D) conversion, YC (Luminance and Color difference) conversion and other conventional processing with the image signal 202 inputted from the image sensor 22. The resulting digital image data 203 are written -to the buffer memory 24. Further, the signal processor 23 compresses the image data 203 when they should be recorded in the recorder 27 as image data 207 or expands such image data 207 read out from the recorder 27, as needed. In addition, to allow a picture to appear on the display 28, the signal processor 23 thins, or reduces, YC data and then analog-converts the thinned YC data. The display 28 displays the image data inputted from the signal processor 23 on an LCD (Liquid Crystal Display) 406 (see FIG. 4) as a picture.

The recorder 27 includes a data recording medium, not shown, and is capable of recording the image data read out from the buffer memory 24 in the data recording medium or reading out the image data from the data recording medium and causing them to be written to the buffer memory 24. The data recording medium may be implemented as, e.g., a memory card loaded with a semiconductor memory or a package accommodating a magneto-optical disk or similar rotatable recording body and may be removably mounted to the recorder 27.

In the movie mode, the signal processor 23 compresses the electric image signal by use of, e.g., a motion JPEG (Joint Photographic cording Experts Group) system and writes the compressed image data in the recorder 27. More specifically, the signal processor 23 stores the electric image signal in the buffer memory 24, processes the image signal read out from the buffer memory 24, and then continuously writes a still picture data in the data recording medium of the recorder 27 with the processed image signal compressed with the motion JPEG system on a picture-by-picture basis.

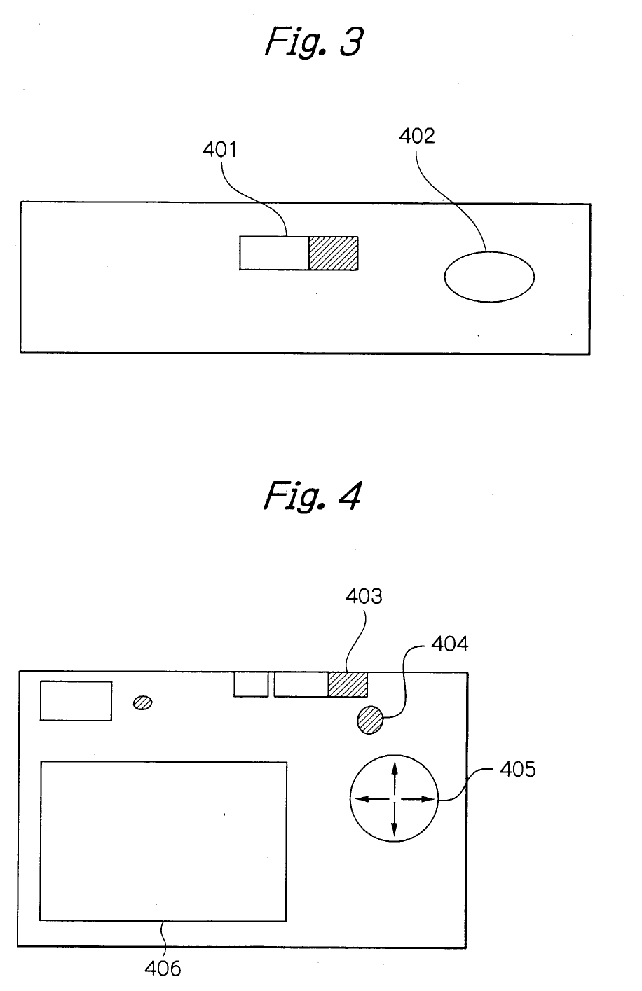

As shown in FIGS. 3 and 4 specifically, the operation panel 32 includes various input and select switches, e.g., a power switch 401, a shutter release button 402, a pickup mode switch 403, a macro button 404 and cursor keys 405. As shown in FIG. 1, the operation panel 32 sends out an operation signal 215 representative of the operator's manipulation of the operation panel 32 to the system controller 31. The pickup mode switch 403, which may be implemented as a slide switch, allows the operator to select either one the still picture and movie modes.

The system controller 31 controls the operation of the entire digital camera 10 in response to the operation signal 215 inputted from the operation panel 32. More specifically, in the illustrative embodiment, the system controller 31 determines whether or not the operator has selected the pickup and macro modes in accordance with the operation signal 215 representative of the states of the pickup mode switch 403 and macro button 404. Particularly, the system controller 31 feeds the control signal 211 representative of the pickup and macro modes to the photometry and range finding controller 25.

In operation, the operator first selects the still picture or movie mode on the pickup mode switch 403 of the operation panel 32 and pushes, if desired, the macro button 404 for selecting the macro mode. Subsequently, when the operator pushes the shutter release button 402, the system controller 31 delivers, based on the operation signal 215 inputted from the operation panel 32, the control signals 212, 211 and 213 or the reference operation frequency (not shown) to the timing generator 26, photometry and range finding controller 25, and signal processor 23. In response, the timing generator 26 generates timing pulses 205 and 206 asynchronous to the reference operation frequency and feeds the timing pulses 205 and 206 to the image sensor 22 and signal processor 23, respectively. Further, in response to the operation signal 215 representative of the states of the pickup mode switch 403 and macro button 404, the system controller 31 determines the states of the pickup and macro modes and feeds the control signal 211 indicative of the above states to the photometry and ranging finding controller 25.

FIG. 2 shows a specific operation at flow of the photometry and range finding controller 25. As shown, the controller 25 determines whether the pickup mode selected by the operator is the still picture or movie modes (step 301). If the pickup mode is the still picture mode, then the controller 25 determines whether or not the macro mode is selected (step 302). If the answer of the step 302 is positive (YES) , then the controller 25 selects the focus scanning range of 1 m to 0.2 m (step 303). The step 303 is followed by the pickup of a still picture (step 305). If the answer of the step 302 is negative (NO) , then the controller 25 selects the focus scanning range of infinity to one meter (step 304). The step 304 is also followed by the step 305.

If the pickup mode selected by the operator is the movie mode, as determined in the step 301, then the controller 25 simply selects the focus scanning range of infinity to 0.2 m (step 310), skipping the step 302. The step 310 is followed by the pickup of a movie (step 311).

In the steps 305 and 311, the controller 25 controls the lens system 21 in accordance with the focus scanning range thus selected and the result of range finding received from the lens system 21, thereby adjusting the focus. The lens system 21 so controlled focuses the image of a subject on the image sensor 22. The image sensor 22 photoelectrically transduces the image of the subject to the electric image signal 202 under the control of the timing generator 26, as stated earlier.

The signal processor 23 executes the previously mentioned processing with the image signal 202 and stores the resulting image signal 203 in the buffer memory 24. The system controller 31 controls the recorder 27 with a control signal 217 such that the recorder 27 controls the writing or the reading of the image signal between the buffer memory 24 and the data recording medium included in the recorder 27. At the same time, the system controller 31 controls the display 28 with a control signal 218. As a result, the image signal stored in the buffer memory 24 is transferred to the display 28 and displayed on the LCD 406, FIG. 4, in the form of a picture.

On the other hand, in the movie mode, even when the range between the subject and the camera 10 is short, the focus can be advantageously adjusted in the same manner as during normal-range pickup within the focus scanning range without regard to whether or not the macromode is selected. The operator can therefore continuously pick up a desired scene in the movie mode without caring about the macro mode.

In the illustrative embodiment, the photometry and range finding controller 25 selects either one of the two focus scanning ranges on the basis of the pickup and macro modes, as stated above. Alternatively, the system controller 31 may be configured to determine the focus scanning range in accordance with the procedure of FIG. 2 and send out the control signal 211 indicative of the focus scanning thus determined to the photometry and range finding controller 25. This successfully reduces the number of signals constituting the control signals 211.

In a specific modification of the illustrative embodiment, the digital camera 10 may be provided with two or more different focusing systems, in which case the photometry and range finding controller 25 may select one of the focusing systems in response to the control signal 211 indicative of the pickup mode. For example, the photometry and range finding controller 25 may select a scanning system in the still picture mode or select a continuous or wobbling control mode in the movie mode. In this case, it is noteworthy that in the movie mode the scanning system is not assigned, and therefore, whether or not the macro mode is selected has no influence on focusing in the movie mode.

In summary, it will be seen that the present invention provides a digital camera capable of being advantageously focused on a desired subject even during short-range pickup. This advantage is derived from the fact that in a still picture mode a focusing time necessary for short-range pickup is reduced when a macro mode is selected while, in a movie mode, a focusing range is broadened without regard to the macro mode.

The entire disclosure of Japanese patent application No. 2002-118875 filed on Apr. 22, 2002, including the specification, claims, accompanying drawings and abstract of the disclosure is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

What is claimed is:

1. A method of automatically focusing a digital camera, comprising:
a first step of selecting either one of a first pickup mode assigned to a still picture and a second pickup mode assigned to a movie;
a second step of selecting either one of a first focus range advantageous for normal-range pickup and a second focus range assigned to a subject positioned in a range shorter than said first focus range; and
a third step of executing, in the first pickup mode, a focusing operation in the focus range selected in said second step or executing, in the second pickup mode, a focusing operation in a range including the first focus range without regard to the focus range selected in said second step.

2. The method in accordance with claim 1, wherein said third step comprises executing, in the second pickup mode, the focusing operation in a range further including the second focus range.

3. The method in accordance with claim 1, wherein said third step executes, in the first pickup mode, the focusing operation with a scanning system or executes, in the second pickup mode, the focusing operation with wobbling control.

4. The method in accordance with claim 1, wherein, in the second step, said first focus range is set from infinity to one meter and said second focus range is set from 1 m to 0.2 m.

5. The method in accordance with claim 2, wherein said third step comprises executing, in the second pickup mode, the focusing operation in a range from infinity to 0.2 m.

6. A digital camera comprising a focus controller for focusing said digital camera on a subject, comprising:
a first selector selecting either one of a first pickup mode assigned to a still picture and a second pickup mode assigned to a movie;
a second selector selecting either one of a first focus range advantageous for normal-range pickup and a second focus range assigned to a subject positioned in a range shorter than said first focus range; and
a controller causing, in the first pickup mode, a focusing operation to be executed in the focus range selected by said second selector or causing, in the second pickup mode, a focusing operation to be executed in a range including the first focus range without regard to the focus range selected by said second selector.

7. The digital camera in accordance with claim 4, wherein said controller causes, in the second pickup mode, the focusing operation to be executed in a range further including the second focus range.

8. The digital camera in accordance with claim 4, wherein said controller causes, in the first pickup mode, the focusing operation to be executed by a scanning system or causes, in the second pickup mode, the focusing operation to be executed by wobbling control.

9. The digital camera in accordance with claim 4, wherein, in the second selector, said first focus range is set from infinity to one meter and said second focus range is set from 1 m to 0.2 m.

10. The digital camera in accordance with claim 5, wherein said controller causes, in the second pickup mode, the focusing operation to be executed in a range from infinity to 0.2 m.
